(19) United States
(12) Patent Application Publication
(10) Pub. No.: US 2024/0323911 A1
(43) Pub. Date: Sep. 26, 2024

(54) WIRELESS NETWORK PAGING

(71) Applicant: ZTE Corporation, Shenzhen (CN)

(72) Inventors: Zhuang LIU, Shenzhen (CN); Xiubin SHA, Shenzhen (CN); Zijiang MA, Shenzhen (CN); Dapeng LI, Shenzhen (CN); Yin GAO, Shenzhen (CN)

(73) Assignee: ZTE Corporation, Shenzhen, GD (CN)

(21) Appl. No.: 18/666,292

(22) Filed: May 16, 2024

Related U.S. Application Data
(63) Continuation of application No. PCT/CN2023/082876, filed on Mar. 21, 2023.

(51) Int. Cl. H04W 68/00; H04W 36/00; H04W 36/08

(52) U.S. Cl. CPC H04W 68/005; H04W 36/0033; H04W 36/08

(57) ABSTRACT

In wireless communication, there may be improved paging communications with user equipment (UE). A network basestation and the UE may rely on paging identity information to calculate Paging Hyperframes (PH) and/or Paging Time Window (PTW). The paging information may include 5G System Temporary Mobile Subscriber Identity (5G-S-TMSI) or HASH identification (ID) information for paging in an inactive state of the UE. The communication of the paging identity information may be during a UE context setup procedure.

### CROSS-REFERENCE TO RELATED APPLICATIONS

This application is a continuation of International Patent Application No. PCT/CN2023/082876, filed Mar. 21, 2023. The contents of International Patent Application No. PCT/CN2023/082876 are herein incorporated by reference in their entirety.

### TECHNICAL FIELD

This document is directed generally to wireless communications. More specifically, in a mobile device communications system, there may be improved paging communications.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for wireless communications in which there may be improved paging communications with user equipment (UE). A network basestation and the UE may rely on paging identity information to calculate Paging Hyperframes (PH) and/or Paging Time Window (PTW). The paging information may include 5G System Temporary Mobile Subscriber Identity (5G-S-TMSI) or HASH identification (ID) information for paging in an inactive state of the UE. The communication of the paging identity information may be during a UE context setup procedure.

In one embodiment, a wireless communication method includes receiving, at a basestation from a core network (CN), a paging identity information during a user equipment (UE) context setup procedure; and calculating, by the basestation with the received paging identity information, a Paging Time Window (PTW) or a Paging Hyperframe (PH) for paging with a UE in an RRC INACTIVE state. The receiving includes: receiving an INITIAL CONTEXT SETUP REQUEST message that includes the paging identity information. The paging identity information compromises 5G-S-TMSI or HASH ID information. The receiving includes: receiving a triggering of a UE context modification procedure; and receiving updates to the paging identity information. The UE context modification procedure includes: receiving a UE CONTEXT MODIFICATION REQUEST message from the CN that includes the paging identity information. The method includes: sending, by the CN, the paging information to an identified target node for a handover of the UE, wherein the identified target node utilizes the paging information for a calculation of the PTW or the PH. The paging identity information is included in a HANDOVER REQUEST or a PATH SWITCH REQUEST ACKNOWLEDGE message sent to the target node by the CN. A source node identifies the target node for handover. The method includes: sending a paging message to another network node with the paging identity information, wherein the another network node uses the paging identity information to calculate the PTW or the PH. The method includes: sending, by a basestation centralized unit (CU), a paging message to a basestation distributed unit (DU) that includes the paging identity information; and calculating, by the basestation DU, the PTW or the PH for paging the UE in the RRC INACTIVE state using the paging identity information.

In one embodiment, a wireless communication method includes sending, by a core network (CN) during a user equipment (UE) context setup procedure, a paging identity information to a basestation; and calculating, at the basestation using the paging identity information, a Paging Time Window (PTW) or a Paging Hyperframe (PH) for paging with a user equipment (UE) in an RRC INACTIVE state. The sending includes: sending an INITIAL CONTEXT SETUP REQUEST message that includes the paging identity information. The paging identity information compromises 5G-S-TMSI or HASH ID information. The receiving includes: triggering of a UE context modification procedure; and sending an update to the paging identity information of the UE to a basestation. The UE context modification procedure includes: sending, to the basestation, a UE context modification request that includes the paging identity information. The method includes: sending the paging information to an identified target node for a handover of the UE, wherein the identified target node utilizes the paging information for a calculation of the PTW or the PH. The paging identity information is included in a HANDOVER REQUEST or a PATH SWITCH REQUEST ACKNOWLEDGE message sent to the target node by the CN. A source node identifies the target node for handover. A paging message is sent to another network node with the paging identity information, wherein the another network node uses the paging identity information to calculate the PTW or the PH. The method includes: sending, by a basestation centralized unit (CU), a paging message to a basestation distributed unit (DU) that includes the paging identity information; and calculating, by the basestation DU, the PTW or the PH for paging the UE in the inactive state using the paging identity information.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows an embodiment of a wireless network system architecture.

FIG. 4 shows a network architecture of a basestation Central Unit (CU) and basestation Distributed Unit (DU).

FIG. 5 shows one embodiment of a session setup process.

FIG. 6 shows one embodiment of a session established.

FIG. 7 shows one embodiment of paging identity information NG communication during handover.

FIG. 8 shows one embodiment of paging identity information Xn communication during handover.

FIG. 9 shows one embodiment of RAN paging with neighbors.

FIG. 10 shows another embodiment of RAN paging with neighbors.

FIG. 11 shows one embodiment of F1 paging.

FIG. 12 shows another embodiment of F1 paging.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

A user equipment (“UE”) device may move between nodes or cells in which case a handover or a change/addition operation may occur to improve network reliability for the UE as it moves. The movement may be from a source cell to a target cell based on a number of potential target cells that are referred to as candidates. The movement between cells may also include a number of target cells that are potential candidate cells. A conditional handover (“CHO”) and a conditional PSCell addition/change (“CPAC”) may include a conditional PSCell change (“CPC”) and/or a conditional PSCell addition (“CPA”). A conditional handover (“CHO”) can reduce handover interruption time and improve mobility reliability. A CHO is a handover that is executed by the UE when one or more execution conditions are met. The UE can evaluate the execution condition(s) upon receiving the CHO configuration, and can stop evaluating the execution condition(s) once the handover is triggered. The CHO configuration may include a candidate PCell configuration generated by a candidate target node and the corresponding execution condition(s) for that candidate cell.

Paging operations in the network may operate differently for relay communications. A paging occasion (“PO”) message source must be determined. For example, in order to monitor the remote UE's PO on behalf of the remote UE, the relay UE may obtain the remote UE's PO information. The frame in which a UE wakes up may be referred to as a paging frame (“PF”). Within a radio frame, there may be subframes and the UE does not remain awake in all 10 subframes. It may wake up in a specific subframe(s) within a paging frame which is/are called a paging occasion (“PO”). In one embodiment, the PO may be calculated as follows:

The paging frame (“PF”) and PO for paging may be determined by the following formula:

System Frame Number (“SFN”) for the PF is determined by:

(SFN+PF_offset) mod T=(T div N)*(UE_ID mod N)

Index (i_s), indicating the index of the PO is determined by:

i_s=floor (UE_ID/N) mod Ns
T: Discontinuous Reception (“DRX”) cycle of the UE (T is determined by the shortest of the UE specific DRX value(s), if configured by RRC and/or upper layers, and a default DRX value broadcast in system information. In RRC_IDLE state, if UE specific DRX is not configured by upper layers, the default value is applied).
N: number of total paging frames in T
Ns: number of paging occasions for a paging frame (“PF”)
PF_offset: offset used for paging frame (“PF”) determination
UE_ID: 5G-S-TMSI (Temporary Mobile Subscriber Identity) mod 1024

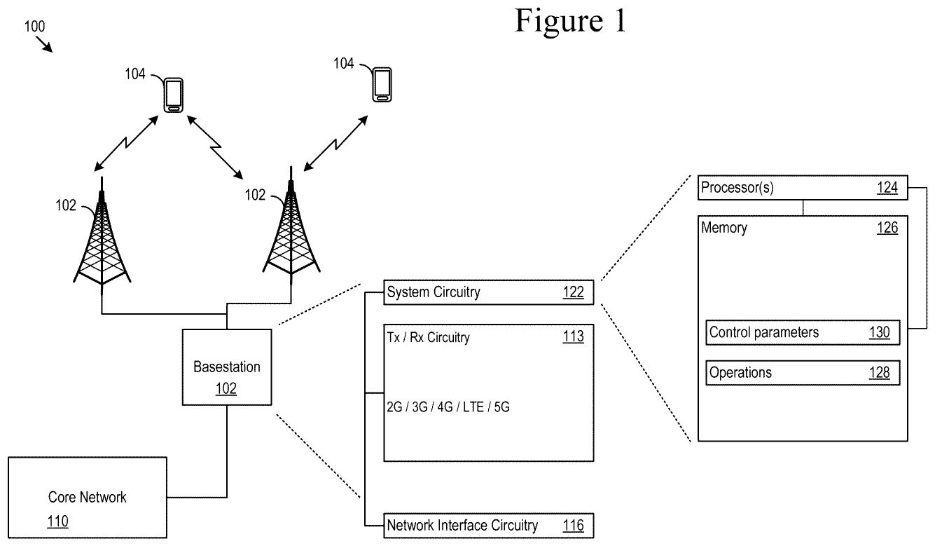

FIG. 1 shows an example basestation 102. The basestation may also be referred to as a wireless network node. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

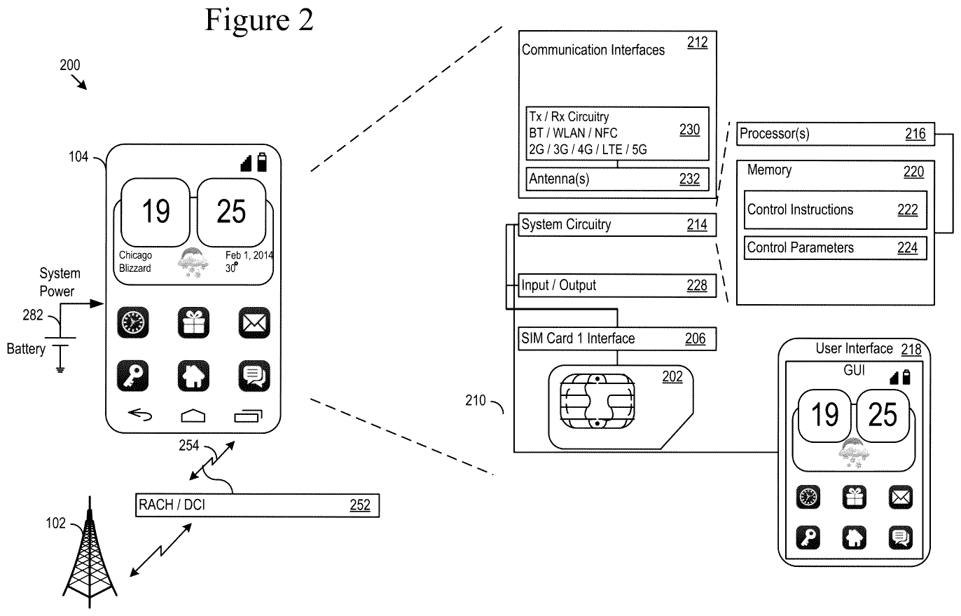

FIG. 2 shows an example random access messaging environment 200. In the random access (RA) messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U(MN) interface instance.

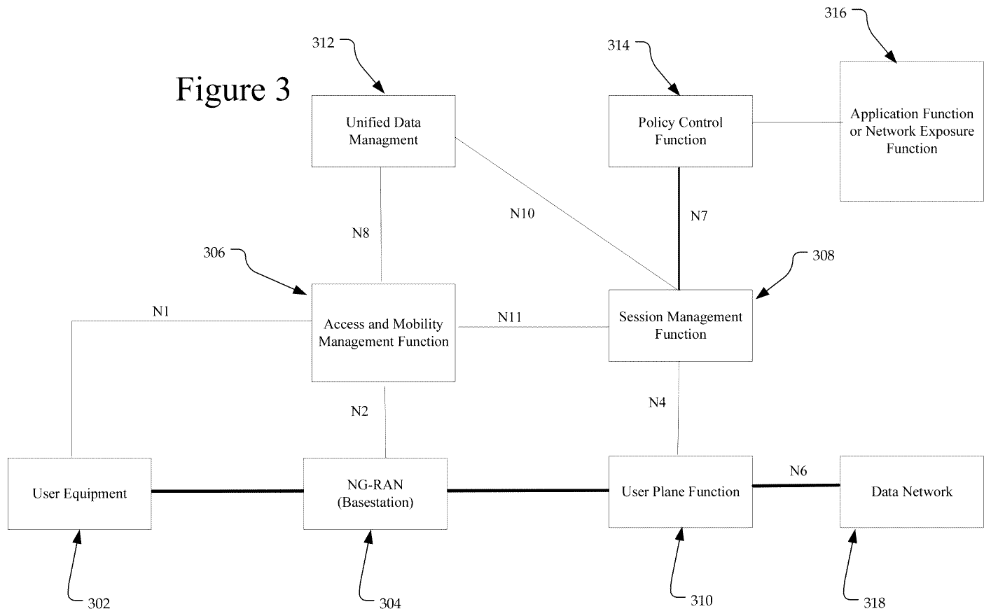

FIG. 3 shows an embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 2 illustrated an example user equipment (“UE”) 104. UE 302 is a device accessing a wireless network (e.g. 5GS) and obtaining service via a NG-RAN node or basestation 304. The UE 302 interacts with an Access and Mobility Control Function (“AMF”) 306 of the core network via NAS signaling. FIG. 1 illustrates an example basestation or NG-RAN 102. The NG-RAN node 304 is responsible for the air interface resource scheduling and air interface connection management of the network to which the UE accesses. The AMF 306 includes the following functionalities: Registration management, Connection management, Reachability management and Mobility Management. The AMF 306 also perform the access authentication and access authorization. The AMF 306 is the NAS security termination and relay the session management NAS between the UE 302 and the SMF 308, etc. As described below, the core network (“CN”) may be components described in FIG. 3, such as the AMF 306.

The SMF 308 includes the following functionalities: Session Management e.g. Session establishment, modify and release, UE IP address allocation & management (including optional Authorization), Selection and control of uplink function, downlink data notification, etc. The user plane function (“UPF”) 310 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 312 manages the subscription profile for the UEs. The subscription includes the data used for mobility management (e.g. restricted area), session management (e.g. QoS profile). The subscription data also includes slice selection parameters, which are used for AMF 306 to select a proper SMF 308. The AMF 306 and SMF 308 get the subscription from the UDM 312. The subscription data may be stored in a Unified Data Repository with the UDM 312, which uses such data upon reception of request from AMF 306 or SMF 308. The Policy Control Function (“PCF”) 314 includes the following functionality: supporting unified policy framework to govern network behavior, providing policy rules to control plane function(s) to enforce the policy rule, and implementing a front end to access subscription information relevant for policy decisions in the User Data Repository. The Network Exposure Function (“NEF”) 316 is deployed optionally for exchanging information with an external third party. In one embodiment, an Application Function (“AF”) 316 may store the application information in the Unified Data Repository via NEF. The UPF 310 communicates with the data network 318.

Access Mobility Function (“AMF”) and Session Management Function (“SMF”) are the control plane entities and User Plane Function (“UPF”) is the user plane entity in new radio (“NR”) or 5GC. The signaling connection between AMF/SMF and MN may be a Next Generation-Control Plane (“NG-C”)/MN interface. The signaling connection between MN and SN may be an Xn-Control Plane (“Xn-C”) interface. The signaling connection between MN and UE may be a Uu-Control Plane (“Uu-C”) RRC interface.

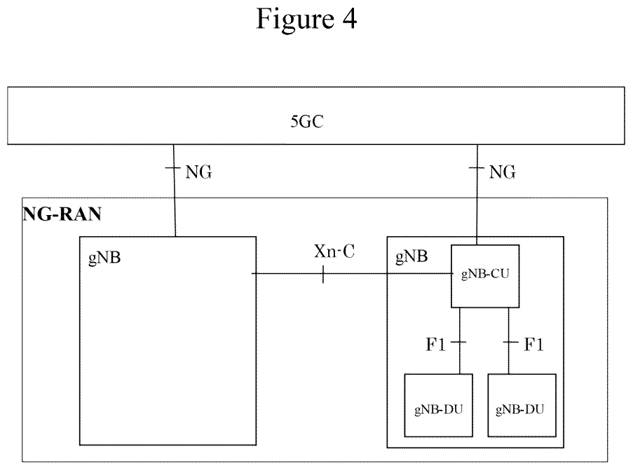

FIG. 4 shows a network architecture of a basestation Central Unit (CU) and basestation Distributed Unit (DU). FIG. 4 illustrates basestations (labeled as “gNB”) that communicate with an overall network (labeled (“5GC”). Basestations can communicate with one another via a control plane interface (“Xn-C”). One basestation is shown as have one CU that is connected to two DUs via an F1 interface. This is merely one example of an arrangement of a basestation. In some embodiments, there may be one or any number of DUs connected with a single CU.

The basestation can be divided into two physical entities named Centralized Unit (“CU”) and Distributed Unit (“DU”). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. The DU(s) are logical node(s) with a subset of the basestation functions, and may be controlled by the CU.

The CU may be a logical node hosting RRC, SDAP and PDCP protocols of the basestation or RRC and PDCP protocols of the basestation that controls the operation of one or more DUs. The DU may be a logical node hosting RLC, MAC and PHY layers of the basestation, and its operation may be at least partly controlled by the CU. A single DU may support one or multiple cells. However, each cell is only supported by a single DU. Each basestation may support many cells. As described in the embodiments herein, the cell mobility between cells may be from different CUs or DUs or may be internal to the CU and/or the DU.

The inter-cell mobility described herein may occur in a number of different examples. There may be intra-DU mobility where a UE changes cells within a single DU. Examples of intra-DU mobility include: 1) PCell change within one DU (may also include PCell change with SCell change); 2) PSCell change within one DU (may also include PSCell change with SCell change); and 3) PCell change within one DU with PSCell change within one DU (may also include SCell change within one cell group). In another mobility embodiment, there may be intra-CU and inter-DU mobility where a UE changes cells between different DUs but within a single CU. Examples of intra-CU and inter-DU mobility include: 1) PCell change across DU but within one CU (may also include PCell change with SCell change); and 2) PSCell change across DU but within one CU (may also include PSCell change with SCell change). In another mobility embodiment, there may be inter-CU mobility where a UE changes cells between different CUs. Examples of inter-CU mobility include: 1) PCell change across CU (may also include PCell change with SCell change); and 2) PSCell change across CU (may also include PSCell change with SCell change).

The UE may use Discontinuous Reception (“DRX”) in RRC_IDLE and RRC_INACTIVE state in order to reduce power consumption. The UE may monitor one paging occasion (“PO”) per DRX cycle. A PO may be a set of PDCCH monitoring occasions with multiple subframes. The PF and PO may be determined by the UE-specific DRX cycle T and UE_ID value as well as the cell-specific Ns, N and PF_offset value. In order to monitor the PO of the remote UE, the relay UE may at least obtain the remote UE's DRX cycle T and UE_ID information. With regard to the UE_ID, there are several alternative embodiments for the acquisition of the remote UE's identification: UE_ID. The options include sending the 5G-S-TMSI of remote UE, utilizing a pseudo UE ID (e.g. 5G-S-TMSI mod 1024) of the remote UE, or calculating the PO(s) of the remote UE.

One Paging Frame (PF) may be one Radio Frame and may contain one or multiple paging occasion PO(s). The UE may only need to monitor one PO for receiving paging message per DRX cycle, which then reduces the power consumption of this UE. Both the UE and the basestation may calculate PF and/or PO for paging based on the same formula, so the UE and RAN can select the same PF and/or PO. Therefore, the basestation can send the paging message to this UE in the calculated PF and/or PO in one DRX cycle, and the UE can monitor the same calculated PF and/or PO to receive the paging message in that DRX cycle.

Discontinuous reception (“DRX”) is a power saving technique. The basic mechanism of DRX is to configure a DRX cycle for UE, and a drx-ondurationTimer to begin a DRX cycle. During the drx-onduration Timer, UE is in ‘DRX On’ state and continues monitoring physical downlink control channel (“PDCCH”). If the UE successfully decodes a PDCCH, the UE stays awake (in ‘DRX On’ state) and starts an inactivity timer. The UE can go to sleep in ‘DRX off’ state after drx-ondurationTimer or drx-inactivityTimer expires. In ‘DRX off’, UE does not monitor PDCCH. The DRX may be used in extended Reality (“XR”) since the XR traffic is period transmitted. However, if DRX is off and UE transmits a SR, the UE will switch back to DRX On and monitor PDCCH. In some embodiments of XR service, uplink pose/control traffic will be generated every 4 ms, and the periodicity of video traffic is 1/60 second, so UE may transmit SR frequently and may affect the DRX procedure (e.g., UE switch back to DRX ON). Hence, frequent UL transmission can decrease the time when UE in ‘DRX off’ and increase UE power consumption.

Newer networks (e.g. 5G) may support Extended DRX (“eDRX”). It may be an extension of the DRX feature that is used by devices to further reduce power consumption. The basic principle for eDRX is to extend DRX cycles to allow a device to remain in a power-saving state for a longer period of time than the DRX cycle. A Hyperframe (Hyper-SFN, H-SFN) is defined for eDRX, comprised of 1024 radio frames (10.24 seconds). When eDRX is enabled for a UE, the UE is reachable for paging in specific Paging Hyperframes (PH) in one eDRX cycle. If the UE is configured with an eDRX cycle less than 1024 radio frames, the UE monitors POs in the configured eDRX cycle. If the UE is configured with the eDRX cycle longer than 1024 radio frames, the UE monitors POs in the specific PHs during a periodic Paging Time Window (PTW) configured for the UE. The PTW is UE-specific and is determined by a Paging Hyperframe (PH), a starting position within the PH (PTW_start) and an ending position (PTW_end).

The basestation and UE may calculate the PH and PTW (PTW_start, PTW_end) similarly. The UE_ID_H which is the 13 most significant bits of the Hashed identification (hash ID) is used in the formula for the PH and PTW calculation. The hash ID may be calculated based on 5G System Temporary Mobile Subscriber Identity (“5G-S-TMSI”) as in the following:

Hashed ID is defined as follows:

Hashed ID is Frame Check Sequence (FCS) for the bits b31, b30 . . . , b0 of 5G-S-TMSI.

5G-S-TMSI=b47, b46, . . . , b0> as defined in TS 23.003 [23].

The 32-bit FCS shall be the ones complement of the sum (modulo 2) of Y1 and Y2, where
Y1 is the remainder of x^{k}+(x³¹+x³⁰+x²⁹+x²⁸+x²⁷+x²⁶+x²⁵+x²⁴+x²³+x²²+x²¹+x²⁰+x¹⁹+x¹⁸+x¹⁷+x¹⁶+x¹⁵+x¹⁴+x¹³+x¹²+x¹¹+x¹⁰+x⁹+x⁸+x⁷+x⁶+x⁵+x⁴+x³+x²+x¹+1) divided (modulo²) by the generator polynomial x³²+x²⁶+x²³+x²²+x¹⁶+x¹²+x¹¹+x¹⁰+x⁸+x⁷+x⁵+x⁴+x²+x+1, where k is 32; and
Y² is the remainder of Y³ divided (modulo 2) by the generator polynomial x³²+x²⁶+x²³+x²²+x¹⁶+x¹²+x¹¹+x¹⁰+x⁸+x⁷+x⁵+x⁴+x²+x¹, where Y³ is the product of x³² by “b31, b30 . . . , b0 of S-IMSI or 5G-S-TMSI”, i.e., Y³ is the generator polynomial x³² (b31*x³¹+b30*x³⁰+ . . . +b0*1).

In order to page a UE configured with the eDRX cycle longer than 1024 radio frames (namely long eDRX), the basestation may need to know the paging identity information for the PN and PTW calculation. The paging identity information includes the UE's 5G-S-TMSI and/or hash ID information of the UE. The 5G S-TMSI may be a shortened version of the 5G Globally Temporary Identifier (“5G-GUTI”), assigned by the core network (“CN”) or the Access and Mobility Control Function (“AMF”) to the UE during initial registration.

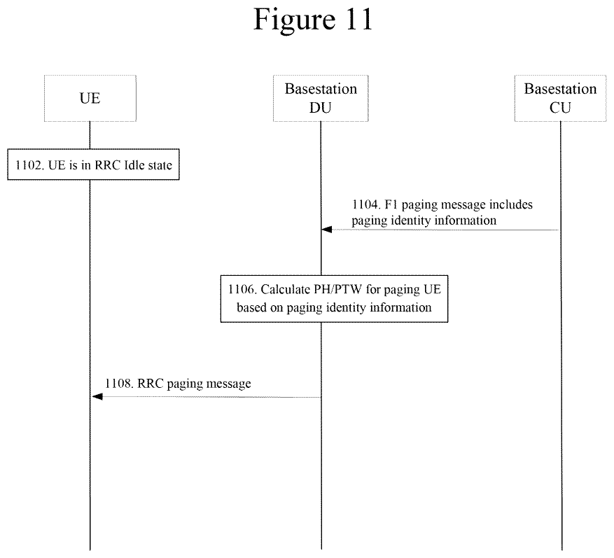

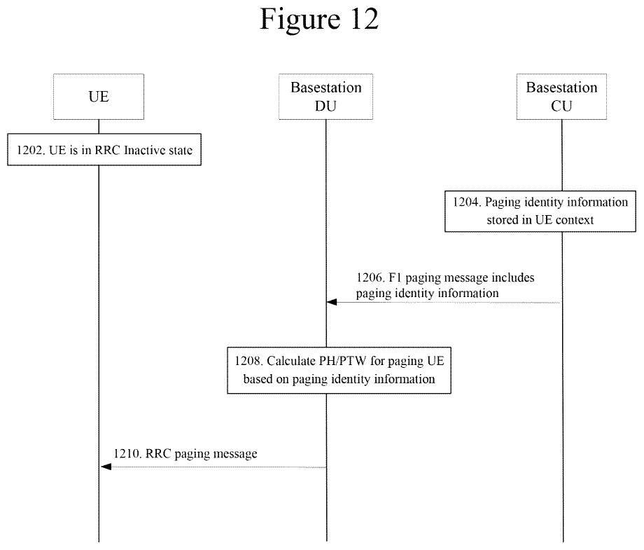

When the CN initiates to page a UE in RRC_idle which is configured with long eDRX, the AMF sends a NGAP paging message to the basestation including the 5G S-TMSI, then the basestation can calculate the PH and PTW to page the UE during the PTW. However, not all basestations in the paging area have the UE's paging identity information (5G-S-TMSI or hash ID information), therefore, if the basestation receiving NGAP paging message needs to page the UE via neighbor basestation(s), the neighbor basestations(s) will fail to page UE. If the basestation is a CU/DU split basestation, there is no UE's paging identity information (5G-S-TMSI or hash ID information) in the DU, so if the basestation needs to page the UE via the DU(s) of this basestation, the DU(s) will fail to page the UE. Embodiments described with respect to FIGS. 11-12 address a CU/DU split basestation.

In RRC_INACTIVE, the last serving basestation node keeps the UE context and the UE-associated NG connection with the serving AMF. In some embodiments, the last serving basestation is aware of the UE's 5G-S-TMSI information (sent by UE via RRC complete message) via the stored UE context, except for the following examples:
if the UE is accessing the network for the initial registration, the UE may have no 5G-S-TMSI assigned by core network (AMF), then it may be impossible for the UE to send the 5G-S-TMSI to the gNB via RRC complete message; and
if the UE has already sent the 5G-S-TMSI assigned by the CN (AMF) to the basestation during the RRC setup procedure, and the basestation stores it in UE context. The 5G-S-TMSI may be assigned by the AMF when UE registers the network. During the current session, the AMF serving for the UE may be different from a last session, or may change during the session, so the new AMF will assign new 5G-S-TMSI to the UE via NAS procedure.

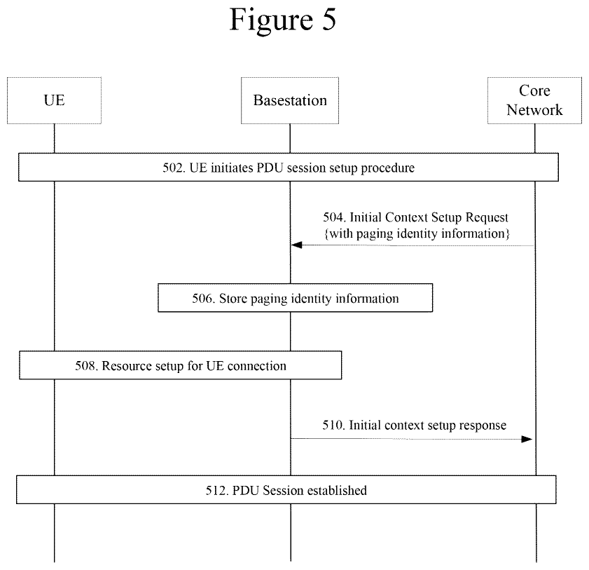

In one embodiment, the 5G-S-TMSI is also used for paging the remote UE in the paging message, so the relay UE can precisely determine whether the remote UE is paged or not. Otherwise, the relay may be unable to determine the specific remote UE(s) indicated in a received paging message. In this embodiment, the relay UE sends the paging messages received within the PO to the remote UE. However, exposing the 5G-S-TMSI may present a potential security risk since it may expose the 5G-S-TMSI of the remote UE to the relay UE over the PC5 interface. In addition, RRC_INACTIVE remote UE may send the I-RNTI (Radio Network Temporary Identifier) to the relay UE so that the relay UE can determine the RAN Based Notification Area (“RNA”) paging of the remote UE. As described below with respect to FIGS. 1-4, a network provider may include a number of network nodes (i.e. basestations) for providing network access to a user equipment (“UE”) device. The network nodes are referred to as basestations in some embodiments. FIGS. 5-12 illustrate example communications for paging according to some embodiments.

The basestation and user equipment (UE) may use the same formula specified in 3GPP to calculate the Paging Hyperframes (PH) and Paging Time Window (PTW) or (PTW_start, PTW_end) to page a UE configured with Extended Discontinuous Reception (cDRX). Paging identity information, such as the 5G-S-TMSI or HASH ID information may be needed for the PH and PTW calculation. In some embodiments, the last serving basestation may fail to page the UE due to lacking of 5G-S-TMSI information of the UE or the UE's 5G-S-TMSI may have changed, of which the basestation is not aware. Not all basestations in the paging area have the UE's paging identity information, so the last serving basestation or the basestation receiving the core network (CN) paging message may need to page the UE via neighbor basestation(s), the neighbor basestation(s) may fail to page the UE. If the basestation is a CU/DU split basestation, there may be no UE's paging identity information in DU, so if the basestation needs to page the UE via the DU(s), the DU(s) may fail to page the UE. The embodiments described herein include examples where the paging identity information communication is improved.

FIG. 5 shows one embodiment of a session setup process. The core network (CN) provides HASH ID information of the UE to the basestation during the UE initial access procedure. In block 502, the UE initiates an initial Protocol Data Unit (PDU) session setup procedure among the UE, the basestation, and the core network (CN). As described, the CN may include the AMF as shown in FIG. 3. In block 504, the CN sends the INITIAL CONTEXT SETUP REQUEST message to the basestation to request setup UE context, including the paging identity information. As described above, the paging identity information may include 5G-S-TMSI or HASH ID information of the UE. In some embodiments, the paging identity information may be included in Core Network Assistance Information for RRC INACTIVE information in this message. The HASH ID may be calculated based on 5G-S-TMSI. The HASH ID information may be the HASH ID or part of bits of the Hashed ID. In block 506, the basestation stores the received paging identity information of the UE for paging the UE in RRC Inactive state. This may be as part of the UE context. The basestation uses the received the paging identity information to calculate Paging Time Window (PTW) and/or Paging Hyperframe (PH) for paging the UE in RRC INACTIVE state. In block 508, the basestation allocates network resource for the UE to establish the connection and PDU session between the UE and the basestation. In block 510, if the basestation has successfully established a network resource for UE for the PDU session, the basestation sends an INITIAL CONTEXT SETUP RESPONSE to the CN. In block 512, data transmission can occur between the UE, the basestation and the CN upon establishment of the PDU session.

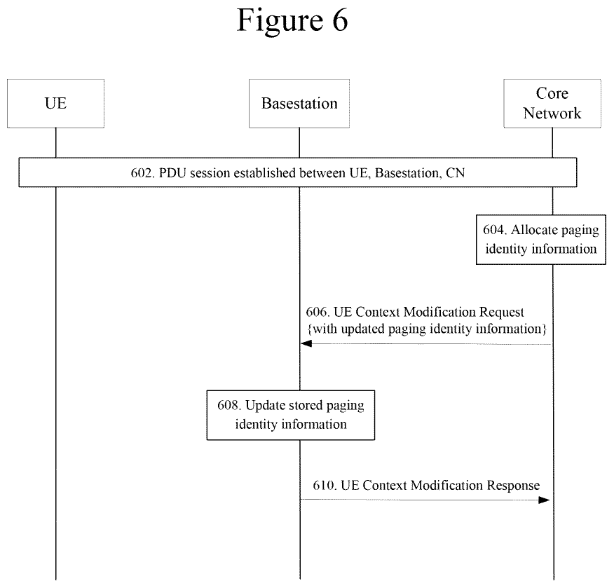

FIG. 6 shows one embodiment of a session established. The CN updates the HASH ID information of the UE to the basestation during a UE connection. In block 602, one or more PDU sessions are successfully established among the UE, the basestation, and the CN. In block 604, the CN may allocate paging identity information (e.g. the new 5G-S-TMSI) to the UE. For example, when the serving AMF for UE is changed, the CN may need to calculate new HASH ID information of the UE based on the new 5G-S-TMSI. In block 606, the AMF sends the INITIAL CONTEXT MODIFICATION REQUEST message to the basestation to request modification of the UE context, including the updated paging identity information (e.g. updated 5G-S-TMSI or updated HASH ID information) of the UE in the message. The paging identity information could be included in Core Network Assistance Information for RRC INACTIVE information in this message. In block 608, upon receiving the updated paging identity information of the UE, the basestation updates the paging identity information in the stored UE context according to the received updated paging identity information. The basestation uses the updated paging identity information to calculate PTW and/or PH for paging the UE in RRC INACTIVE. In block 610, the basestation sends INITIAL CONTEXT MODIFICATION RESPONSE to the CN.

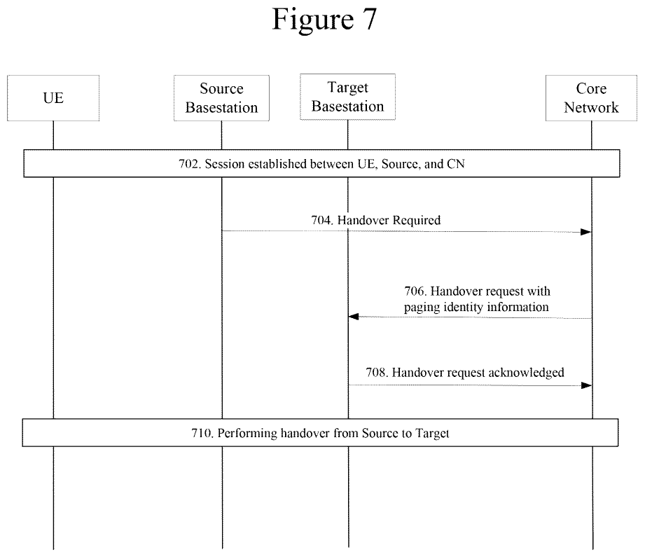

FIG. 7 shows one embodiment of paging identity information NG communication during handover. The embodiment may include HASH ID information delivery during the NG based handover. The handover may be from a source basestation to a target basestation. In block 702, the UE has connected with the source basestation. During the UE mobility, the source basestation identifies a target basestation for handover. If there is no interface connection (e.g. Xn interface) between the source basestation and the target basestation, the source basestation sends a HANDOVER REQUIRED message to the basestation for requesting handover to the target basestation as in block 704. In block 706, the CN sends a HANDOVER REQUEST message via NG interface to the target basestation, including the paging identity information of the UE in the message. The paging identity information may be included in Core Network Assistance Information for RRC INACTIVE information in this message. The target basestation uses the received the paging identity information to calculate PTW and/or PH for paging the UE in RRC INACTIVE. In block 708, if the target basestation can accept the handover, the target basestation sends a HANDOVER REQUEST ACKNOWLEDGE message to the CN. In block 710, a handover is performed from source basestation to the target basestation.

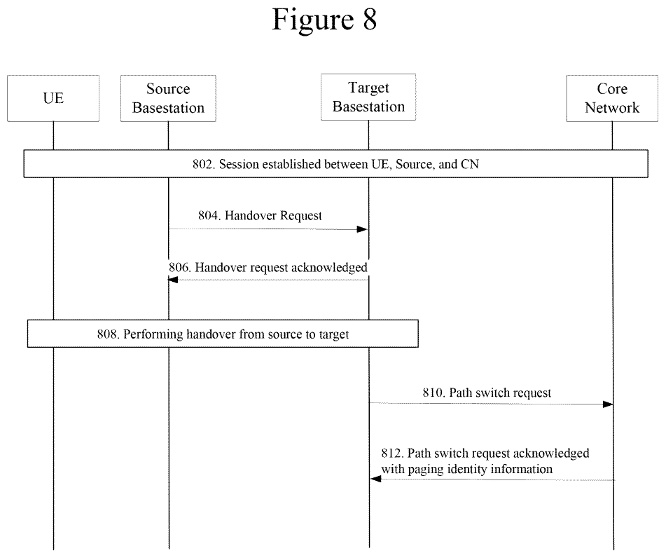

FIG. 8 shows one embodiment of paging identity information Xn communication during handover. HASH ID information may be delivered during the Xn based handover. In block 802, the UE has connected with the source basestation for establishing a session. During the UE mobility, the source basestation identifies a target basestation for handover. If there is interface connection (Xn interface) between the source basestation and the target basestation, the source basestation send HANDOVER REQUEST message to the basestation for requesting handover to the target basestation in block 804. In block 806, if the target basestation can accept the handover, the target basestation sends a HANDOVER REQUEST ACKNOWLEDGE message to the source basestation. In block 808, a handover is performed from the source basestation to the target basestation. In block 810, after handover, the target basestation sends a PATH SWITCH REQUEST message to the CN to inform the new serving basestation. In block 812, the CN sends the PATH SWITCH REQUEST ACKNOWLEDGE message to the target basestation, including the paging identity information of the UE in the message. The paging identity information may be included in Core Network Assistance Information for RRC INACTIVE information in this message. The target basestation uses the received paging identity information to calculate PTW and/or PH for paging the UE in RRC INACTIVE.

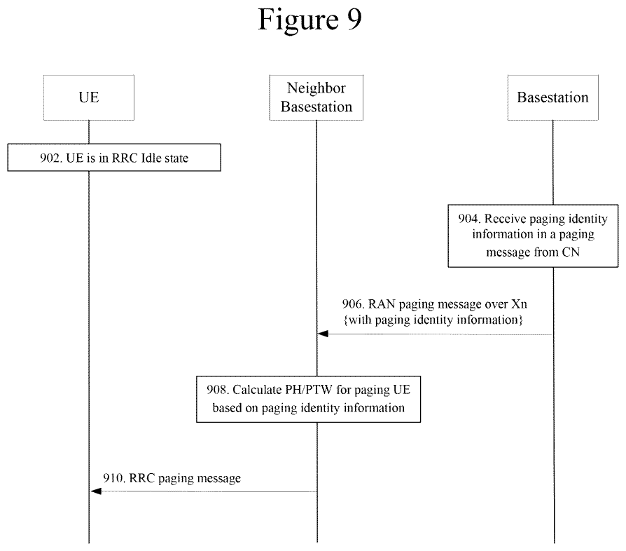

FIG. 9 shows one embodiment of RAN paging with neighbors. The embodiment includes RAN paging with the UE in RRC idle state, through a neighbor basestation. In block 902, the UE stays in the RRC IDLE state. In block 904, the basestation may receive a CN initiated paging message over the NG interface to page the UE in RRC IDLE. The paging identity information may be included in this message. If just the 5G-S-TMSI is included, then the basestation may calculate the HASH ID information based on the 5G-S-TMSI. If the basestation is only aware of the 5G-S-TMSI for the UE, the basestation can calculate the HASH ID information based on the 5G-S-TMSI received from CN paging message or stored in the UE context. In block 906, the basestation sends a RAN paging message to the neighbor basestation through the Xn interface to page UE via the neighbor basestation, which includes the paging identity information of the UE in the message. The RAN paging message may include an eDRX configuration for the UE. If the UE is configured with long eDRX cycles (e.g, larger than 10.24 seconds), the neighbor basestation can calculate the PTW and/or PH in block 908. The calculation is based on the received paging identity information of the UE for paging the UE in the RRC IDLE state. In block 910, the neighbor basestation send an RRC paging message according to the calculated PH/PTW to page the UE.

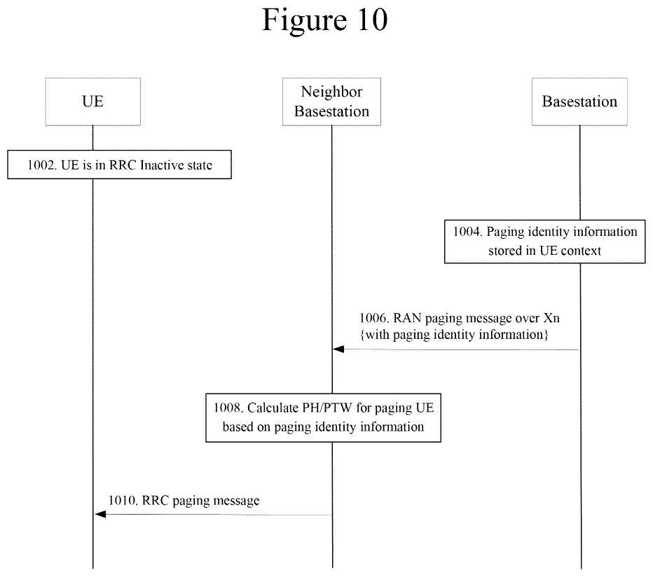

FIG. 10 shows another embodiment of RAN paging with neighbors. The embodiment includes RAN paging with the UE in RRC inactive state through a neighbor basestation. In block 1002, the UE stays in the RRC INACTIVE state. In block 1004, the basestation (which is the last serving basestation for the UE) is aware of the paging identity information based on the stored UE context (e.g, sent by CN in any of the prior embodiments shown with respect to FIGS. 5-9). If the basestation is only aware of the 5G-S-TMSI for the UE, the basestation can calculate the HASH ID information based on the 5G-S-TMSI received from CN paging message or stored in the UE context. In block 1006, the basestation sends a RAN paging message to the neighbor basestation through the Xn interface to page UE via the neighbor basestation, which includes the paging identity information of the UE in the message. The RAN paging message may include an eDRX configuration for the UE. If the UE is configured with long eDRX cycles (e.g, larger than 10.24 seconds), the neighbor basestation can calculate the PTW and/or PH in block 1008. The calculation is based on the received paging identity information of the UE for paging the UE in the RRC INACTIVE state. In block 1010, the neighbor basestation send an RRC paging message according to the calculated PH/PTW to page the UE.

FIG. 11 shows one embodiment of F1 paging. This embodiment illustrates an example with a DU/CU basestation split. As shown, the paging the UE in RRC IDLE may be with a neighbor DU. In block 1102, the UE stays in the RRC IDLE state. In block 1104, the basestation-CU may receive the paging identity information of the UE from CN initiated paging message. Alternatively, the basestation-CU may receive the paging identity information of the UE from another basestation initiated RAN paging message. If the basestation-CU is only aware of the 5G-S-TMSI for the UE, then the basestation-CU can optionally calculate the HASH ID information based on the 5G-S-TMSI. The basestation-CU may send F1 paging message to the basestation-DU of the same basestation via F1 interface to page UE via the basestation-DU, including the paging identity information of the UE in the message. The F1 paging message also includes an eDRX configuration for the UE. If the UE is configured with long eDRX cycle (e.g, larger than 10.24 seconds), the basestation-DU may use the received the HASH ID information to calculate PTW and/or PH for paging the UE in RRC IDLE in block 1106. In block 1108, the basestation-DU sends an RRC paging message according to the calculated PH/PTW to page the UE.

FIG. 12 shows another embodiment of F1 paging. This embodiment illustrates an example with a DU/CU basestation split. As shown, the paging the UE in RRC INACTIVE may be with a neighbor DU. In block 1202, the UE stays in the RRC INACTIVE state. In block 1204, the basestation-CU (which is the last serving basestation for the UE) is aware of the paging identity information based on the stored UE context (e.g, sent by CN in any of the prior embodiments shown with respect to FIGS. 5-11). If the basestation-CU is only aware of the 5G-S-TMSI for the UE, the basestation can calculate the HASH ID information based on the 5G-S-TMSI received from CN paging message or stored in the UE context. In block 1206, the basestation-CU may send F1 paging message to the basestation-DU of the same basestation via F1 interface to page UE via the basestation-DU, including the paging identity information of the UE in the message. The F1 paging message also includes an eDRX configuration for the UE. If the UE is configured with long eDRX cycle (e.g, larger than 10.24 seconds), the basestation-DU may use the received the HASH ID information to calculate PTW and/or PH for paging the UE in RRC INACTIVE. The basestation-DU may use the received the 5G-S-TMSI information to calculate PTW and/or PH for paging the UE in RRC INACTIVE in block 1208. In block 1210, the basestation-DU sends an RRC paging message according to the calculated PH/PTW to page the UE.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A wireless communication method comprising:
receiving, at a basestation from a core network (CN), a paging identity information during a user equipment (UE) context setup procedure; and
calculating, by the basestation with the received paging identity information, a Paging Time Window (PTW) or a Paging Hyperframe (PH) for paging with a UE in an RRC INACTIVE state.

2. The wireless communication method of claim 1, wherein the receiving comprises:
receiving an INITIAL CONTEXT SETUP REQUEST message that includes the paging identity information.

3. The wireless communication method of claim 1, wherein the paging identity information compromises HASH ID information.

4. The wireless communication method of claim 1, wherein the receiving comprises:
receiving a triggering of a UE context modification procedure; and
receiving updates to the paging identity information.

5. The wireless communication method of claim 4, wherein the UE context modification procedure comprising:
receiving a UE CONTEXT MODIFICATION REQUEST message from the CN that includes the paging identity information.

6. The wireless communication method of claim 1, further comprising:
sending, by the CN, the paging identity information to an identified target node for a handover of the UE, wherein the identified target node utilizes the paging identity information for a calculation of the PTW or the PH.

7. The wireless communication method of claim 6, wherein the paging identity information is included in a HANDOVER REQUEST or a PATH SWITCH REQUEST ACKNOWLEDGE message sent to the target node by the CN.

8. (canceled)

9. The wireless communication method of claim 1, further comprising:
sending a paging message to another network node with the paging identity information, wherein the another network node uses the paging identity information to calculate the PTW or the PH.

10. The wireless communication method of claim 1, further comprising:
sending, by a basestation centralized unit (CU), a paging message to a basestation distributed unit (DU) that includes the paging identity information; and
calculating, by the basestation DU, the PTW or the PH for paging the UE in the RRC INACTIVE state using the paging identity information.

11. A wireless communication method comprising:
sending, by a core network (CN) during a user equipment (UE) context setup procedure, a paging identity information to a basestation; and
calculating, at the basestation using the paging identity information, a Paging Time Window (PTW) or a Paging Hyperframe (PH) for paging with a user equipment (UE) in an RRC INACTIVE state.

12. The wireless communication method of claim 11, wherein the sending comprises:
sending an INITIAL CONTEXT SETUP REQUEST message that includes the paging identity information.

13. The wireless communication method of claim 11, wherein the paging identity information compromises HASH ID information.

14. The wireless communication method of claim 11, wherein the receiving comprises:
triggering of a UE context modification procedure; and
sending an update to the paging identity information of the UE to a basestation.

15. The wireless communication method of claim 14, wherein the UE context modification procedure comprises:
sending, to the basestation, a UE context modification request that includes the paging identity information.

16. The wireless communication method of claim 11, further comprising:
sending the paging identity information to an identified target node for a handover of the UE, wherein the identified target node utilizes the paging identity information for a calculation of the PTW or the PH.

17. The wireless communication method of claim 16, wherein the paging identity information is included in a HANDOVER REQUEST or a PATH SWITCH REQUEST ACKNOWLEDGE message sent to the target node by the CN.

18. (canceled)

19. The wireless communication method of claim 11, wherein a paging message is sent to another network node with the paging identity information, wherein the another network node uses the paging identity information to calculate the PTW or the PH.

20. The wireless communication method of claim 11, further comprising:
sending, by a basestation centralized unit (CU), a paging message to a basestation distributed unit (DU) that includes the paging identity information; and
calculating, by the basestation DU, the PTW or the PH for paging the UE in the inactive state using the paging identity information.

21. A wireless communications apparatus comprising:
a memory storing a plurality of instructions; and
a processor configured to execute the plurality of instructions, and upon execution of the plurality of instructions, is configured to:
receive, from a core network (CN), a paging identity information during a user equipment (UE) context setup procedure; and
calculate, with the received paging identity information, a Paging Time Window (PTW) or a Paging Hyperframe (PH) for paging with a UE in an RRC INACTIVE state.
